(19) United States
(12) Patent Application Publication
(10) Pub. No.: US 2011/0115280 A1
(43) Pub. Date: May 19, 2011

(54) CYCLE WHEEL AND METHODS FOR MANUFACTURING SUCH A WHEEL

(75) Inventors: Jean-Pierre MERCAT, Chavanod (FR); Fabrice AUGRIS, Cusy (FR)

(73) Assignee: SALOMON S.A.S., Metz-Tessy (FR)

(21) Appl. No.: 12/949,140

(22) Filed: Nov. 18, 2010

(30) Foreign Application Priority Data
Nov. 19, 2009 (FR) 09 05551
Nov. 19, 2009 (FR) 09 05552

(51) Int. Cl. B60B 1/02; B23P 17/00

(52) U.S. Cl. 301/55; 29/894.33

(57) ABSTRACT

A cycle wheel and methods of manufacture of such a wheel. The cycle wheel has tensioned spokes between a hub and a rim and is equipped with a wheel fairing attached to the rim. The rim is provided with two grooves for receiving two radially outer edges of the wheel fairing, and the rim exerts, in the area of the two grooves, a centripetal force that blocks the radially outer edges of the wheel fairing in the grooves.

### CROSS-REFERENCE TO RELATED APPLICATION

The instant application is based upon the French priority Patent Applications No. 09.05551, filed Nov. 19, 2009, and No. 09.5552, filed Nov. 19, 2009, the disclosures of which are hereby incorporated by reference thereto, and the priorities of which are hereby claimed under 35 U.S.C. §119.

### BACKGROUND

1. Field of the Invention

The invention relates to a cycle wheel with tension spokes between a hub and a rim for receiving a tire, the wheel being equipped with a wheel fairing attached on the rim.

2. Background Information

In the field of cycles, in particular competition bicycles, tension spoke wheels equipped with so-called “aerodynamic” rims for reducing the drag of bicycle wheels and improving the performance of cyclists are known. The rims of these wheels currently are mainly made of a carbon-based composite, which makes them expensive to produce and limits their use in high-end or competition cycles.

The document U.S. Pat. No. 6,961,999 discloses a unitary aluminum rim having a radially inner portion that is profiled to improve its aerodynamics. Such a rim is difficult to bend, due to its radial height, and it is also heavy.

It is also known from the document WO-A-97/18098 to make a wheel rim out of a plastic material molded by injection; such a rim includes two circular crowns connected by plastic material bridges, these material bridges being relatively heavy. Moreover, the plastic material structure of the rim limits its lifespan, because the material relaxes when working in compression. Such a rim is therefore not adapted for use in the field of tension spoke wheels.

Furthermore, from the document FR-A-2 344 411 a bicycle wheel is known which includes a rim on which a half spindle-shaped wheel fairing made of molded PVC is attached and equipped with slots allowing the spokes of the wheel to pass therethrough. The wheel fairing is fixed on the rim using screws, which are difficult to reach and capable of becoming loose during the lifespan of the wheel.

In known wheels, the manufacture of the wheel fairing is a complex operation that requires relatively large quantities of material; and the cost per unit of the material used can be high, in particular in the case of a carbon-based composite. Moreover, the known wheel fairings are relatively heavy, which decreases performance for the wheels of the state of the art.

### SUMMARY

The invention overcomes the aforementioned disadvantages by providing a new wheel, the aerodynamics of which make it possible to improve the performance of a cyclist, and which does not have the limitations of the state of the art.

To this end, the invention relates to a cycle wheel with tension spokes extending between a hub and a rim equipped with a structure for receiving a tire, such wheel being equipped with a wheel fairing attached to the rim. According to an aspect of the invention, the rim of the wheel is equipped with two grooves for receiving two radially outer edges of the wheel fairing, and the rim exerts, in the area of the two grooves, a centripetal force, i.e., a radially inward force, that blocks the radially outer edges of the wheel fairing in the grooves. According to another aspect of the invention, the wheel fairing of the wheel is made of a thermoformed plastic material or a composite material with thermoformable matrix.

In the context of the invention, a wheel is comprised of a rim, a hub, a wheel fairing, and a set of spokes tensioned between the rim and the hub. Such a wheel is adapted to be equipped with a tire, with which it constitutes a “fitted wheel” or, simply, a “wheel and tire assembly.”

Based upon a particular feature of the invention, the wheel fairing is efficiently maintained in position on the rim, without it being necessary to use screws or other attached fasteners, which ensures durability for the assembly carried out between the rim and the wheel fairing, while limiting the risks of vibrations of the wheel fairing when the wheel is being used. In addition, it is contemplated that the wheel fairing can be maintained in position on the rim with the use of neither fastener nor adhesive.

Based upon another aspect of the invention, the wheel fairing can be made from a thin plate or sheet of material, at high production rates, and in a relatively simple mold. The wheel fairing can, therefore, be made light and inexpensive.

According to advantageous but non-limiting aspects of the invention, such a wheel can incorporate one or more of the following characteristics, taken in any technically acceptable combination:
Each groove has a radial depth greater than 0.5 mm; a radial depth greater than 0.8 mm in a particular alternative embodiment; and, in another particular alternative embodiment, a radial depth equal to 1 mm. This ensures that the radially outer edges of the wheel fairing are efficiently anchored in the grooves of the rim.
The two radially outer edges of the wheel fairing are set back, transversely inward of the wheel fairing, with respect to the outer surface of the wheel fairing.
The rim is made of aluminum, or of an aluminum-based alloy, whereas the wheel fairing is made of a plastic material, injected or thermoformed, composite material with thermoplastic or thermohardening matrix, aluminum or aluminum alloy.
The wheel fairing includes two half-shells, each forming one of the radially outer edges of the wheel fairing, the half-shells being affixed to one another in the vicinity of a radially inner edge of the wheel fairing.
The wheel fairing is made of a thermoformed plastic material.
Each wall of the wheel fairing is equipped with a stiffener, which enables it to withstand a buckling force resulting from the centripetal force exerted by the rim.
The wheel fairing includes two half-shells made of a thermoformed plastic material, such half-shells being affixed to one another in the vicinity of an radially inner edge of the wheel fairing.
The half-shells are affixed to one another by welding, gluing, or mechanical assembly of two radially inner edges that are part of the two half-shells, respectively. According to a first method of construction, the two radially inner edges of the two half-shells are welded to one another, lateral surface against lateral surface or edge surface to edge surface. According to another method, the radially inner edges are welded to a connecting ring arranged in the inner volume of the wheel fairing. According to still another method, the radially inner edges are assembled by means of rivets or screws.
The radially inner edges of the two half-shells are covered with a finish ring or an assembly rod to hold the edges together.
The plastic material of the wheel fairing, for thermoforming, is a multi-layer sheet or plate of material having a thickness of less than 1 mm or, in an alternative embodiment, on the order of 0.5 mm.
The thermoformed plastic material is at least partially transparent, whereas a decoration is affixed on the inner surface of the wheel fairing and is visible therethrough.
The rim is equipped with two grooves for receiving two radially outer edges of the wheel fairing, and the rim exerts, in the area of the two grooves, a centripetal force that blocks the radially outer edges of the wheel fairing in these grooves, i.e., that secures together the radially outer edges of the wheel fairing and the grooves of the rim.

The invention also relates to a first method for manufacturing a wheel as mentioned hereinabove, such method including:
(a) manufacturing an open rim blank, with two grooves being arranged on the side of the blank adapted to face the hub;
(b) manufacturing the wheel fairing;
(c) engaging the two radially outer edges of the wheel fairing in the two grooves, over a portion of their circumference;
(d) closing the blank around the wheel fairing by maintaining the radially outer edges of the wheel fairing in place in the grooves;
(e) fastening the spokes to the rim;
(f) fastening the spokes to the hub; and
(g) tensioning the spokes.

The invention also relates to a second method for manufacturing a wheel as mentioned hereinabove, such method including:
(a′) manufacturing a circular rim equipped with two grooves on its side adapted to face the hub;
(b′) manufacturing the wheel fairing;
(c′₁) bringing the flange to a temperature below the temperature range for normal use of the wheel, or bringing the rim to a temperature above the temperature range for normal use of the wheel;
(c′₂) radially arranging the wheel fairing inside the rim, with the radially outer edges of the wheel fairing being opposite the grooves of the rim;
(d′) bringing the wheel fairing and the rim to room temperature;
(e′) fastening the spokes to the rim;
(f′) fastening the spokes to the hub; and
(g′) tensioning the spokes.

The invention also relates to a third method for manufacturing a wheel as mentioned hereinabove, this method including:
(a″) manufacturing a circular rim equipped with two grooves on its side adapted to face the hub;
(b″) manufacturing two constituent half-shells of the wheel fairing;
(c″₁) assembling a first half-shell on the rim by engaging a radially outer edge of the first half-shell in a first of the grooves of the rim;
(c″₂) assembling a second half-shell on the rim by engaging a radially outer edge of the second half-shell in the second of the grooves of the rim;
(d″) affixing the respective radially inner edges of the first and second half-shells to one another;
(e″) fastening the spokes to the rim;
(f′) fastening the spokes to the hub; and
(g″) tensioning the spokes.

In the three methods outlined above, the order of steps (a) and (b), (a′) and (b′) or (a″) and (b″) can be reversed. In these three methods, the tension of the spokes and/or the pressure of a tire mounted on the rim can be provided to be used to exert, on the rim, the centripetal force that contributes to the hooping of the radially outer edges of the wheel fairing in the grooves of the rim.

The invention also relates to a fourth method for manufacturing a wheel as mentioned hereinabove and, more particularly, a method for manufacturing a wheel including (a1) thermoforming a sheet of plastic material to form at least a portion of the wheel fairing.

Advantageously, the fourth manufacturing method further includes:

(b1) thermoforming two half-shells;
(c1) assembling the two half-shells to form the wheel fairing; and
(d1) mounting the wheel fairing on the rim.

Advantageously, in the fourth method, preceding (a1), a decoration is affixed on a surface of the sheet. In this case, the decoration can be provided to be affixed on the aforementioned surface of the sheet by sublimation of a decorative film.

### BRIEF DESCRIPTION OF DRAWINGS

The invention will be better understood and other advantages thereof will become more apparent from the following description of several embodiments of a wheel, consistent with its principle, and methods for manufacturing such a wheel, provided by way of example, with reference to the annexed drawings, in which:

FIG. 1 is a perspective view of a wheel according to the invention;

FIG. 2 is a partial radial cross section, on a larger scale, taken along the plane II of FIG. 1;

FIG. 3 is a view, on a larger scale, of the detail III of FIG. 2;

FIG. 4 is a perspective partial view of the wheel of FIGS. 1 and 2 during manufacture;

FIG. 5 is a functional diagram of a mold used for manufacturing the fairing of the wheel of FIGS. 1 to 4, in a first configuration;

FIG. 6 is a view, on a larger scale, of the detail VI of FIG. 5;

FIG. 7 is a view, similar to FIG. 6, but on a smaller scale, when the mold is in a second configuration of use;

FIG. 8 is a view, similar to FIG. 7, when the mold is in a third configuration of use;

FIG. 9 is a perspective view of a thermoplastic material sheet used in the mold of FIGS. 5 to 8;

FIG. 10 is a partial cross section, on a larger scale, taken along the line X-X of FIG. 9;

FIG. 11 is a perspective view, similar to FIG. 10, at the end of the thermoforming operation carried out in the mold of FIGS. 6 to 8;

FIG. 12 is a perspective view, similar to FIG. 9, after removal of the unnecessary portions of the thermoformed sheet;

FIG. 13 is a view corresponding to the detail XIII of FIG. 2, for a wheel according to a second embodiment of the invention;

FIG. 14 is a cross section, similar to FIG. 2, for a wheel according to a third embodiment of the invention;

FIG. 15 is a cross section, similar to FIG. 14, showing the wheel being manufactured, in another cross-sectional plane;

FIG. 16 is a schematic diagram representation of a wheel according to the second embodiment of manufacture using an alternative method, during a particular portion of this method;

FIG. 17 is a representation, similar to FIG. 16, during a subsequent part of the manufacturing method;

FIG. 18 is a view corresponding to the detail XVIII of FIG. 14, for a wheel according to a fourth embodiment of the invention;

FIG. 19 is detailed view, similar to FIG. 18, for a wheel according to a fifth embodiment of the invention;

FIG. 20 is a detailed view, similar to FIG. 18, for a wheel according to a sixth embodiment of the invention;

FIG. 21 is a detailed view, similar to FIG. 18, for a wheel according to a seventh embodiment of the invention;

FIG. 22 is a detailed view, similar to FIG. 18, for a wheel according to an eighth embodiment of the invention;

FIG. 23 is a perspective view, in the direction of the arrow XXIII of FIG. 20; and

FIG. 24 is a detailed view, similar to FIG. 18, for a wheel according to a ninth embodiment of the invention.

### DETAILED DESCRIPTION

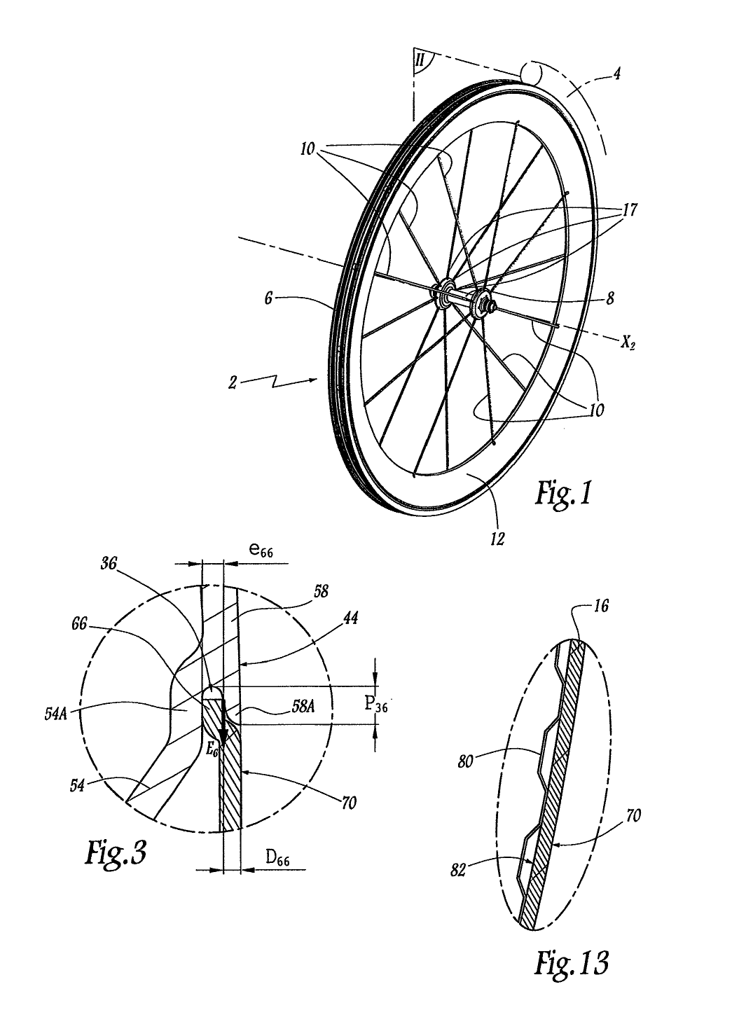

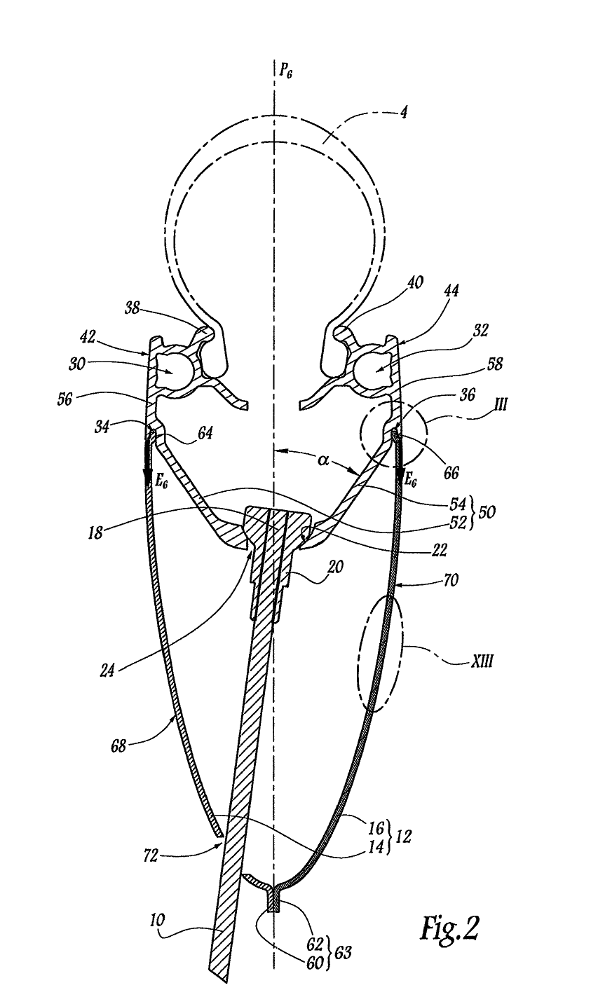

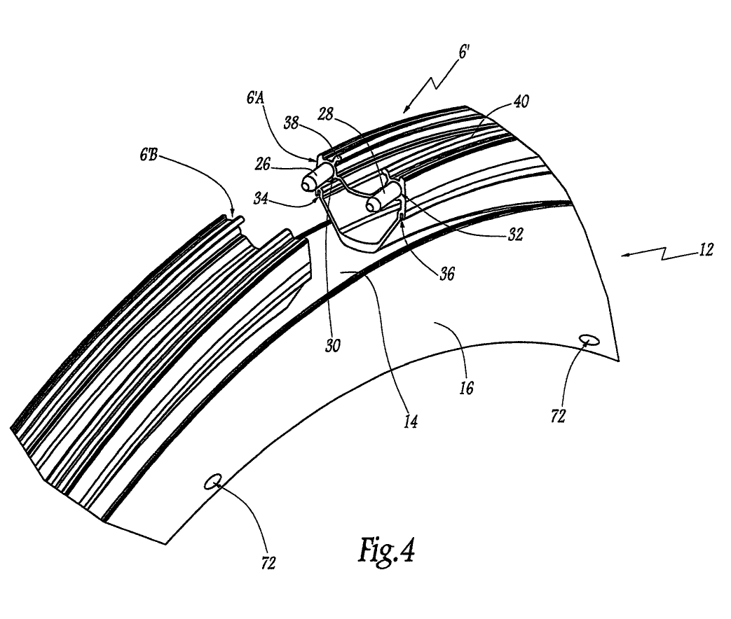

The wheel 2 shown in FIGS. 1 to 4 is adapted to be equipped with a tire 4 shown partially in dot-and-dash lines in FIGS. 1 and 2. In the context of the present application, a tire can be beaded tire, sometimes referred to as a clincher tire, with the beads adapted to cooperate with respective ones of the flanges of the rim, or a tubular tire, sometimes referred to as a tubular tire, which is secured to the rim with adhesive.

The wheel 2 includes a rim 6 made of aluminum or aluminum alloy, e.g., and a hub 8, made of metal, e.g., adapted to be attached to a portion of a bicycle, i.e., the front fork in the illustrated embodiment of FIG. 1, the wheel 2 being a front bicycle wheel. The invention is also applicable to a rear bicycle wheel equipped with a cogset.

Spokes 10, made of metal, e.g., are tensioned between the rim 6 and the hub 8.

A wheel fairing 12 is also part of the wheel 2 and is comprised of two half-shells 14 and 16, made by thermoforming a sheet 100 of thermoplastic material containing Polymethylmethacrylate (PMMA), as described below.

Each spoke 10 is fastened via a first end 17 to the hub 8 (see FIG. 1), by means of complementary structures of the hub and the end 17 of the spoke known to those skilled in the art, and its second end 18 is threaded (see FIG. 2). A nut 20 screwed onto the end 18 is brought into support against a seat 22 formed around an opening 24 arranged in the rim 6 for the passage of the spoke, thereby enabling the tensioning of the spoke, also known to those skilled in the art.

The rim 6 is obtained by aluminum profiling. That is, the rim is made from an extrusion of aluminum, or from an extrusion of an aluminum alloy. The profile element obtained by being bent along a helical shape. Thus, by sectioning the bent profile element into two substantially aligned portions of the helical shape, a radially outwardly open rim blank 6′ is obtained, in the form of a 360° helix section. The rim 6 is then made from this blank 6′ by butt joining the ends 6′A and 6′B of the sectioned blank and by connecting them by means of pins 26 and 28 engaged in corresponding housings 30 and 32 of the profile element, which are located at the two ends of the blank 6′.

The rim 6 is provided with two grooves 34 and 36, which extend on the side of the rim that is adapted to face the hub 8, in the assembled configuration of the wheel 2, i.e., opposite the ribs 38 and 40 cooperating with the tire 4 fitted on the wheel 2.

A median plane P₆ of the rim 6 is a plane perpendicular to the axis of rotation X₂ of the wheel 2, the plane P₆ being equidistant from the outer lateral surfaces 42 and 44 of the rim 6. The rim 6 includes a portion 50, bowl-shaped in the cross section of FIG. 2, at the bottom of which the openings 24 are defined, and which comprises two generally truncated inclined sections 52 and 54, which are symmetrical with respect to the plane P₆ and which extend with respect to this plane at an angle α of about 45°.

The grooves 34 and 36 are arranged in the attachment zones of the inclined sections 52 and 54 on the sides 56 and 58, respectively, of the rim 6, which demarcate the surfaces 42 and 44. More precisely, and as shown in FIG. 3, the groove 36 is arranged between an end portion 54A of the inclined section 54 and an extension 58A of the side 58, in the direction of the hub 8.

The radial depth P₃₆ of the groove 36 is the distance between the bottom of the groove 36 and the free edge of the extension 58A, taken parallel to the plane P₆. This depth is equal to 1.0 mm in the example shown. It can be less, insofar as it remains greater than 0.5 mm or, alternatively, greater than 0.8 mm.

The half-shells 14 and 16 of the fairing 12 are each provided with a radially inner edge 60, 62, respectively, these edges being welded to one another to constitute the radially inner edge 63 of the wheel fairing 12, i.e., the edge of the wheel fairing that faces the axis X₂. Each edge 60 or 62 curves towards the axis X₂, and the edges are in surface-to-surface support against one another, i.e., in abutment of their opposite lateral surfaces. The radially inner edge of the wheel fairing is relatively spaced from the wheel axis. The wheel fairing covers the rim. However, it does not cover the wheel entirely, as is the case with lenticular wheels.

The half-shells 14, 16 have transversely spaced apart radially outer edges 64 and 66, respectively. That is, they are spaced apart axially, i.e., in a direction parallel to the axis X₂ of the hub. The edge 66 has a thickness e₆₆ slightly less than the width of the inlet of the groove 36, i.e., less than the distance between the portions 54A and 58A, taken perpendicular to the plane P₆. However, the thickness of the edge 66 is slightly greater than the width of the bottom of the groove 36. Due to the centripetal force exerted on the wheel fairing by the rim, the edge 66 is guided toward the bottom of the groove and is thus pinched by the latter. This configuration enables a better axial positioning of the wheel fairing.

The edge 66 is set back, on the side of the plane P₆, with respect to the outer lateral surface 70 of the half-shell 16, in the vicinity of the edge 66. In other words, the edge 66 is offset, parallel to the axis X₂, by a non-zero distance d₆₆ with respect to the surface 70. This enables the surfaces 44 and 70 to be substantially in alignment with one another, when the edge 66 is engaged in the groove 36, and improves the aerodynamics of the wheel 2.

In the same fashion, the edge 64 is set back inwardly, i.e., in the direction of the plane P₆, with respect to the outer lateral surface 68 of the half-shell 14, so that the surfaces 42 and 68 are in the prolongation of one another, i.e., so that they are co-extensive.

In the assembled configuration of the wheel 2, shown in FIGS. 1 to 3, the rim 6 exerts, on each edge 64 and 66, and in the vicinity of the grooves 34 and 36, a component of force E₆ parallel to the plane P₆ and centripetal, i.e., directed towards the axis X₂. In other words, the rim 6 constitutes a circular band, or hoop, for the wheel fairing 12 which it constrains due to the distributed centripetal force E₆ that is exerted on the edges 64 and 66 of the half-shells 14 and 16. This centripetal hooping force E₆ results from the tightening of the rim 6 around the wheel fairing 12.

Indeed, if the wheel fairing 12 is made by thermoforming and assembling the half-shells 14 and 16, the rim blank 6′ obtained by sectioning the helical profile element, as mentioned above, can be arranged around the wheel fairing 12 by engaging a portion of the edges 64 and 66 in the grooves 34 and 36. Then, the blank 6′ is closed to make the circular rim 6 by engaging the pins 26 and 28 carried by one of its ends, the end 6′A in the example, into the corresponding housings 30 and 32 of the other end 6′B, while ensuring that the edges 64 and 66 of the half-shells 14 and 16 are kept in position in the grooves 34 and 36, respectively. This step of “closing” the blank 6′ can be followed by a step of welding its ends 6′A and 6′B to one another.

The respective dimensions of the rim 6 and of the wheel fairing 12 are such that, in the closed configuration of the rim, the rim exerts the radially inwardly directed force E₆, which ensures that the edges 64 and 66 are firmly kept in position in the grooves 34 and 36, respectively. Moreover, the tensioning of the spokes 10, which takes place after closing the rim 6, contributes to increasing the magnitude of the force E₆, as well as the force due to the pressure prevailing in the tire 4, when the tire is fitted on the wheel 2 and is inflated.

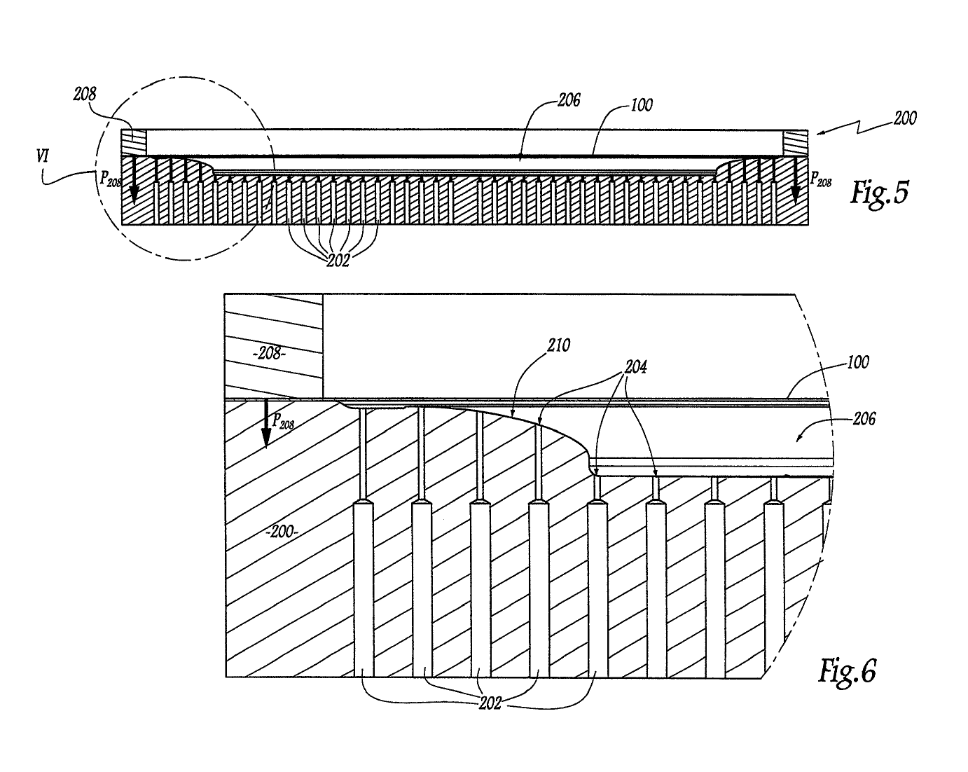

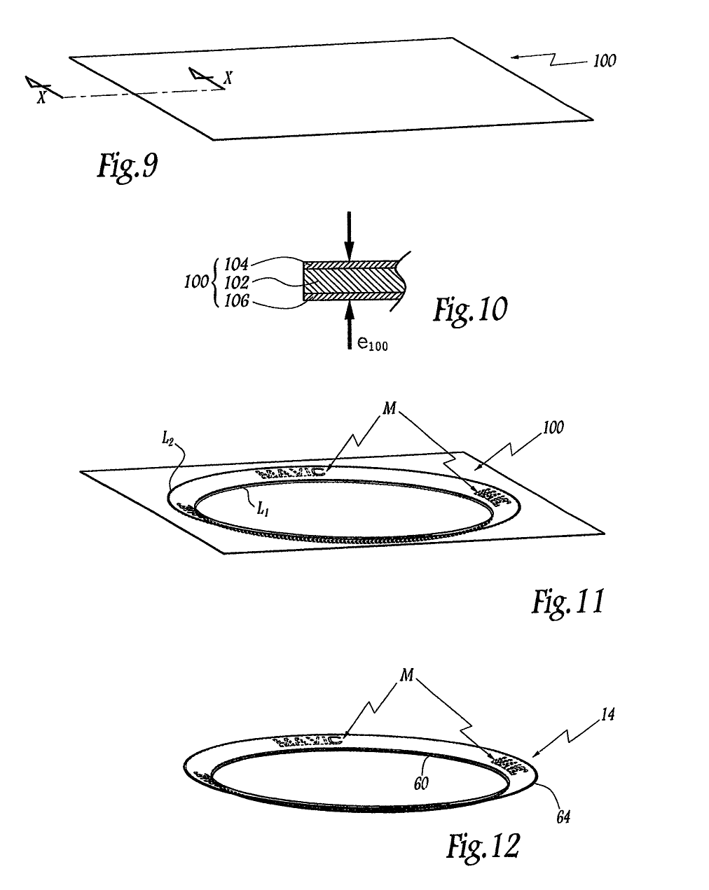

As shown in FIGS. 5 to 12, each half-shell 14, 16 of the fairing 12 is made from a thermoplastic material sheet 100, which includes a core 102 made of PMMA and two finish layers 104 and 106. The total thickness e₁₀₀ of the sheet 100 is 0.5 mm, or at least 0.5 mm. The thickness could be greater, for example about 1.0 mm, insofar as it is compatible with shaping by thermoforming. The PMMA has the particular advantage of having a relatively high modulus of elasticity, on the order of 3000 MPa.

To manufacture the half-shell 14, the sheet 100 is positioned in a mold 200 equipped with suction conduits 202 opening out via corresponding orifices 204 in the mold cavity 206. A blank holder 208 maintains the sheet 100 on the edges of the mold 200 and ensures the sealing created by a pressure force P₂₀₈ directed towards the mold.

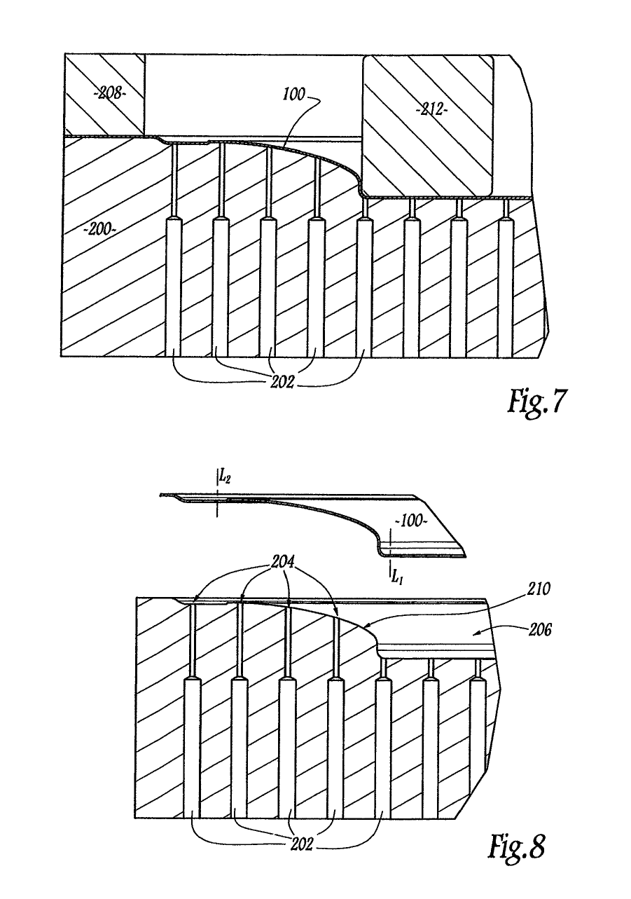

A radiant heating device is arranged above the mold 200, equipped with the sheet 100 and is activated for several seconds, until the sheet 100 is brought to a temperature that is sufficient for the sheet to be deformable by means of a suction carried out by connecting the various conduits 202 to a vacuum source, not shown. As a result, the sheet 100 is drawn against the conformation surface 210 of the mold 200. The process then moves from the configuration of FIG. 6 to the configuration of FIG. 7. As shown in FIG. 7, a punch 212 can accompany the descent of the sheet 100 against the surface 210 and contribute in deforming the sheet. The punch 212 is optional.

The sheet 100 is then allowed to cool for several seconds; the punch 212 and blank holder 208 are removed and air is injected into the conduits 202, which causes the formed sheet 100 to be ejected from the cavity 206, while cooling.

The foregoing leads to the configuration shown in FIG. 8, in which the thermoformed sheet 100 can be removed from the mold and then brought to a cutting tool in order to be cut out along the lines L₁ and L₂ represented by the vertical markings in FIG. 8. The lines L₁ and L₂ are circles that demarcate the radially inner and outer edges, respectively, of the half-shell 14. The cutout in the area of the lines L₁ and L₂ can also be made by laser, water jet or any other device so adapted.

FIG. 11 shows the sheet 100 after having been removed from the mold 200, i.e., in the configuration of FIG. 8, whereas FIG. 12 shows a half-shell 14 after the operations of cutting along the lines L₁ and L₂.

When the half-shell 14 is in the configuration of FIG. 12, openings 72 for passage of the spokes 10 are made therein, at regular intervals.

The thermoforming technique used to make the half-shell 14 makes it possible to decorate it while it is flat, prior to being thermoformed in the mold 200. To this end, the inner finish layer 106 (see FIG. 10) can bear a decoration affixed by sublimation of a decorative film. This decoration can be defined by taking into account the deformation provided in the mold 200 for the sheet 100, so that the decoration has a shape that is aesthetically acceptable after thermoforming.

According to a completely advantageous aspect of the invention, the thermoplastic material(s) used to make the sheet 100 is/are transparent, at least in the area of the zones on which the decorative pattern is applied, which makes it possible to see this pattern through the half-shell 14, once the half-shell is made.

Thus, the core of the sheet 100 can be made not only of PMMA but also out of polycarbonate (PC), Acrylonitrile-Butadiene-Styrene (ABS), a mixture of ABS and PC, polypropylene (PP), etc. Polypropylene has the advantage of being particularly economical, even if its modulus of elasticity is relatively low, about 600 MPa.

In an alternative, the sheet 100 can be made of a composite material whose matrix is thermoformable; such matrix can be one of the materials mentioned above. The matrices of composites with thermoplastic matrix are generally polyamide, polypropylene or PEEK (Polyether ether ketone).

The decorative element can be affixed on the inner side of the half-shell 14, i.e., on the layer 106 that constitutes the inner surface of the sheet 100 after thermoforming, so that it is protected from external attacks. In this regard, the outer finish layer 104 can be provided to resist scratches, ultraviolet rays, and the chemical aggression of cleaning products, for example. The layer 104 can have a thickness of about 1 micrometer, for example.

As shown in FIGS. 11 and 12, the decorative pattern M can be a logo, a word, or a set of words, for example. Further, the decorative pattern can also be a set of colors producing a pearlescent effect, fluorescent effect, metalized or reflective effect, or a hologram drawing, etc.

According to another approach, the decoration of the half-shell 14 can be obtained by tampography, after thermoforming, on one of its inner or outer surfaces.

According to still another approach, a treatment such as “physical vapor deposition” (PVD) can be used to make a metal or metallic oxide deposit on the half-shell 14, such as on its outer finish layer 104 or, in the absence of such a layer, directly on the outer surface of the core 102. This makes it possible to obtain a metallic appearance for the half-shell 14 and contribute to its rigidification. This treatment by means of PVD is carried out by depositing a very thin copper conducting sub-layer, of less than 1 μm, on the half-shell 14, and then by making a chromium or nickel electrolytic deposit, with a thickness of about 0.1 mm. This provides excellent rigidity to the half-shell 14.

The half-shell 16 is identical to the half-shell 14 and is made using the same manufacturing method.

When the two half-shells are manufactured using one of the above-mentioned methods, they are assembled, as explained above, to constitute the wheel fairing 12, before the rim 6 is closed around the wheel fairing 12.

It is then possible to position the spokes 10 by engaging them in the openings 24 of the rim 6, and then to fasten them on the hub 8 before tensioning them by means of the nipples 20.

In the embodiments of the invention shown in FIG. 13 and subsequent drawing figures, the elements that are similar to those of the first embodiment bear the same reference numerals. Hereinafter, only that which distinguishes each of the embodiments over the embodiment of FIGS. 1 to 12 is described.

In the embodiment of FIG. 13, the half-shell 16 is equipped with an inner skin 80 welded locally onto its inner surface 82. This makes it possible to stiffen the half-shell 16 in order to withstand a buckling force that is exerted within this half-shell, between its radially outer edge 66 and its radially inner edge 62, under the effect of the force E₆. The inner skin 80 thus constitutes a stiffener for the half-shell 16. In this embodiment, the shell 14 is also equipped with an inner skin 80 forming a stiffener. All the walls of the wheel fairing 12 are therefore provided with a stiffener.

Other stiffening structures are encompassed within the scope of the invention, such as a sandwich structure or a foam panel, for example.

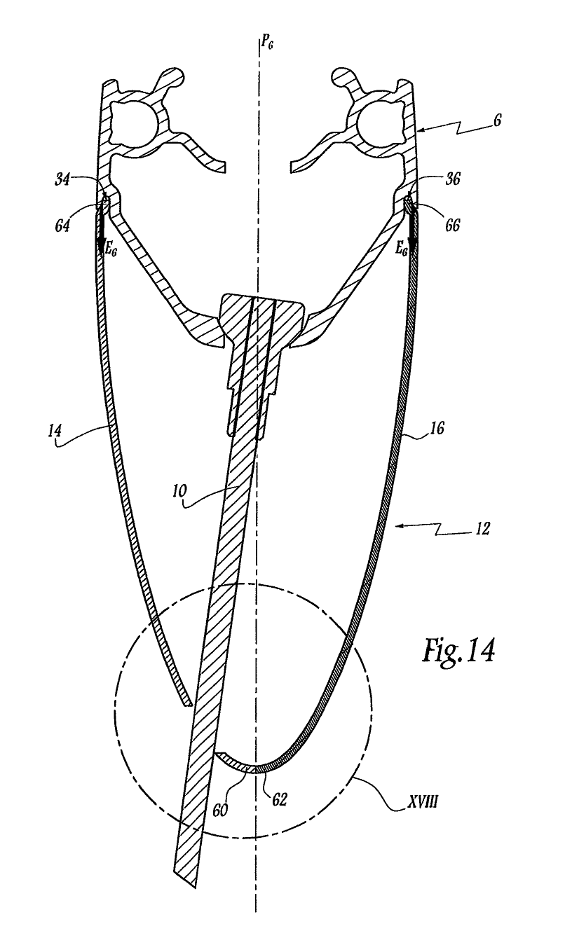

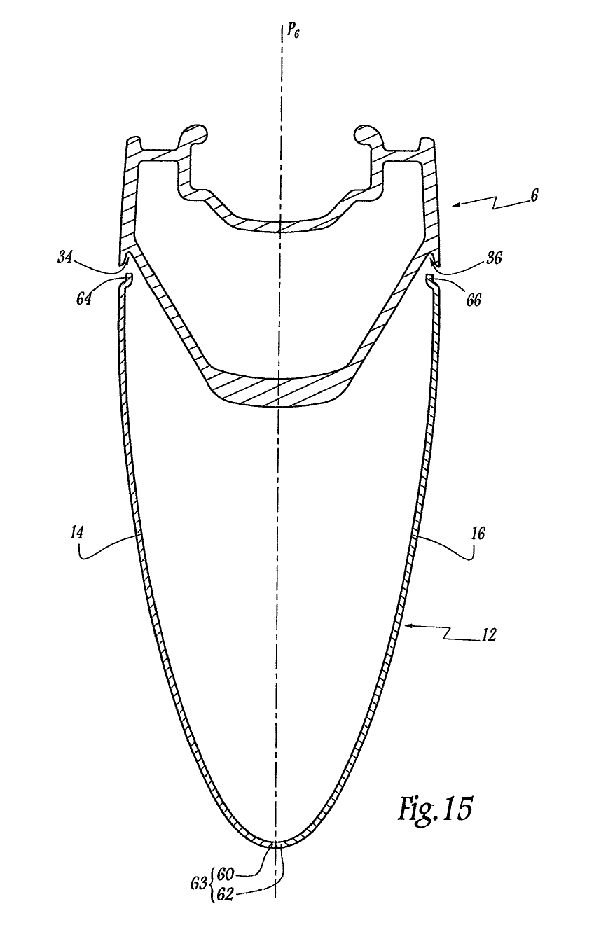

In the third embodiment of the invention shown in FIGS. 14 and 15, the radially inner edges 60 and 62 of the half-shells 14 and 16 are joined edge face to edge face, which renders the radially inner edge 63 more aesthetic than in the first embodiment. In an alternative, these edges can be welded to one another.

Moreover, the mode of assembly of the rim 6 and the wheel fairing 12 is different from that of the first embodiment. The rim 6 is first made in its annular form, whereas the wheel fairing 12 is also made by gluing the half-shells 14 and 16 in the area of the edge 63.

The wheel fairing 12 is then subjected to a temperature of −40° C. for several minutes, while the rim 6 is kept at room temperature. The temperature of −40° C. is substantially lower than the temperature range for use of the wheel 2, which is between −15° C. and +45° C. Insofar as the dilation coefficient of a thermoplastic material, such as the materials mentioned above, is about 80·10⁻⁶/° C. and, in the case of a wheel fairing having a diameter equal to approximately 600 mm, a cooling at 60° C., corresponding to the passage of the wheel fairing from a temperature of 20° C. to a temperature of −40° C., has the effect of reducing the diameter of the radially outer edges 64 and 66 of the half-shells 14 and 16 by approximately 3.0 mm. This makes it possible to position the wheel fairing 12 radially within the rim 6, by centering it radially on the central axis of the rim and axially on the plane P₆ with the edges 64 and 66 substantially aligned with the grooves 34 and 36, respectively, as shown in FIG. 15, which is a cross section in a radial plane of the wheel, spaced from the spokes 10 of the wheel.

The assembly formed by the elements 6 and 12 is then brought to room temperature, which allows the wheel fairing 12 to dilate radially, such that the edges 64 and 66 engage and lock in the grooves 34 and 36, respectively, when entering into the configuration of FIG. 14. In this configuration, the rim 6 exerts a centripetal force E₆, which is directed towards the rotational axis X₂ of the wheel 2 and blocks the edges 64 and 66 in the grooves 34 and 36, respectively.

In an alternative, instead of lowering the temperature of the wheel fairing 12, the rim 6 can be heated to dilate it radially and to allow an assembly using an approach close to that explained with reference to FIG. 15.

In the two methods mentioned above, it is possible to assemble the half-shells 14 and 16 on the blank 6′ or on the rim 6 prior to fixing these half-shells in the area of their respective radial edges 60 and 62.

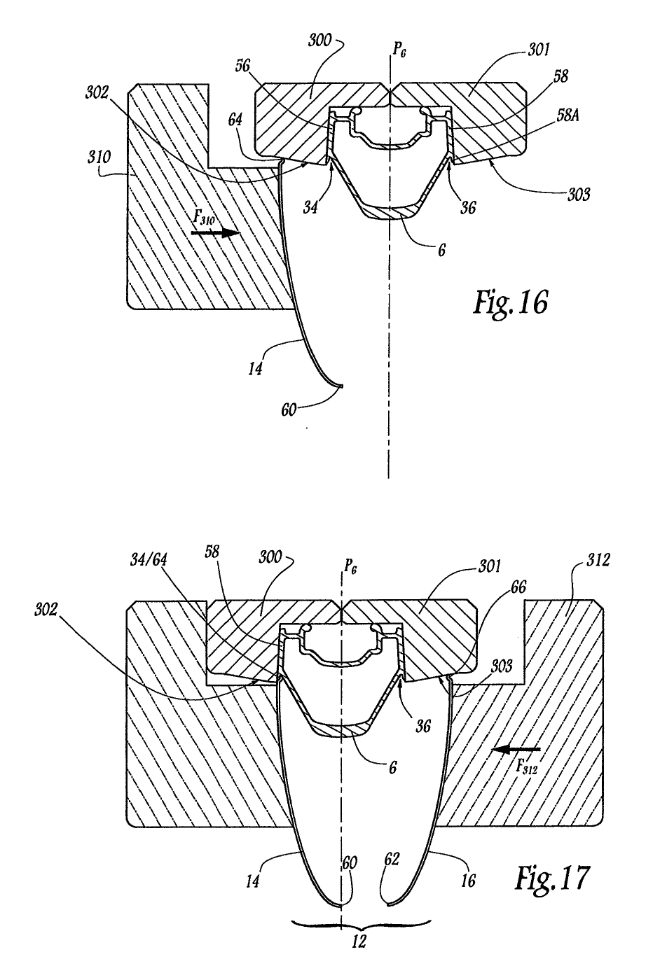

Moreover, the wheel 2 of the third embodiment can be manufactured according to the method depicted in FIGS. 16 and 17. According to this method, the rim 6 is immobilized between two clamping jaws 300 and 301. Each jaw 300 and 301 is equipped with a ramp 302, 303, respectively, inclined with respect to the plane P₆, and which ends in the vicinity of the extensions 58A and equivalent of the sides 56 and 58 of the rim 6 which laterally demarcate the grooves 34 and 36.

The half-shell 14 is positioned on the rim 6 by means of a pusher 310 that moves perpendicular to the plane P₆, and in the direction of such plane, as represented by the arrow F₃₁₀. The pusher 310 can be made of a pliable or flexible material, such as an elastomer, for example, in order to avoid scratching the half-shell 14. The movement F₃₁₀ of the pusher 310 takes place while the radially outer edge 64 of the half-shell 14 slides against the ramp 302, until the edge 64 engages in the groove 34. That position is shown in FIG. 17, as another pusher 312 can be used to move the second half-shell 16, which slides on the ramp 303, until its radially outer edge 66 engages in the groove 36. The respective radially inner edges 60 and 62 of the half-shells 14 and 16 are then opposite one another and can be welded or glued together.

In other words, according to this method, the wheel fairing 12 is finalized after the half-shells 14 and 16 are mounted onto the rim 6.

It is to be understood that the clamping jaws 300 and 301 are circular, such that the ramps 302 and 303 are truncated. This makes it possible to uniformly deform the half-shells 14 and 16, centripetally and elastically, around an axis perpendicular to the plane P₆ and passing through the center of the rim 6, when the edges 64 and 66 slide on the ramps 302 and 303.

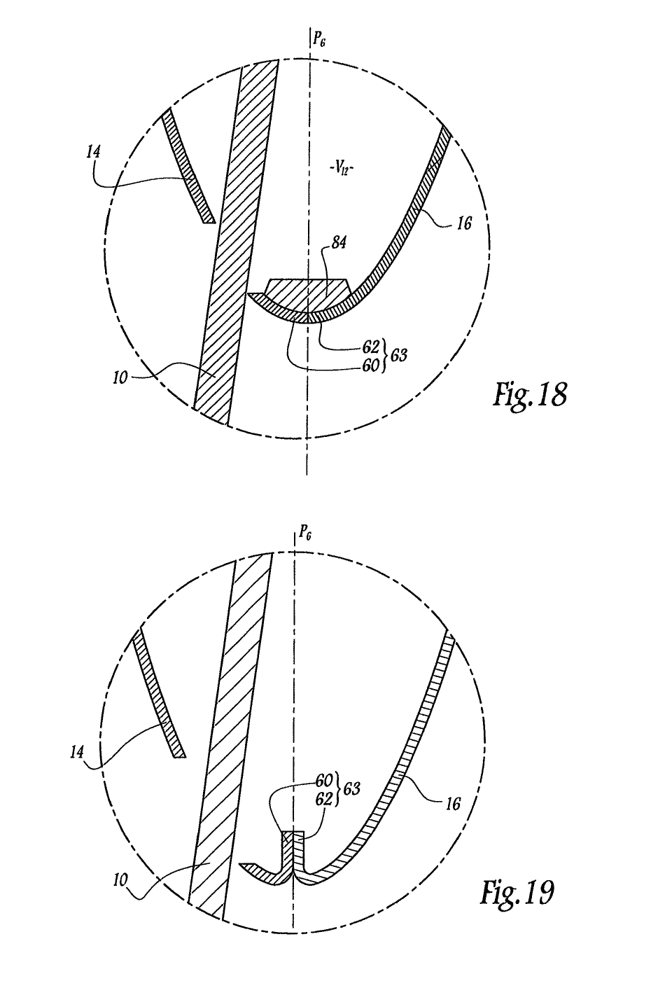

In the fourth embodiment of the invention shown in FIG. 18, the respective radially inner edges 60 and 62 of the half-shells 14 and 16 are welded by laser, edge surface to edge surface and on a reinforcing ring 84 made of a material similar to that forming the core of the half-shells 14 and 16. The ring 84, which makes the connection between the edges 60 and 62, is arranged in the inner volume V₁₂ of the wheel fairing 12.

In the fifth embodiment of the invention shown in FIG. 19, the radially inner edges 60 and 62 of the half-shells 14 and 16 are welded by laser, lateral surface against lateral surface, and in the inner volume V₁₂ of the wheel fairing 12; this provides the radially inner edge 63 of the wheel fairing with a particular appearance, seen from the outside.

In such an embodiment, it is necessary to bend the radially inner edges 60 and 62 under heat after cutting out the sheet 100 and prior to welding together the edges 60, 62.

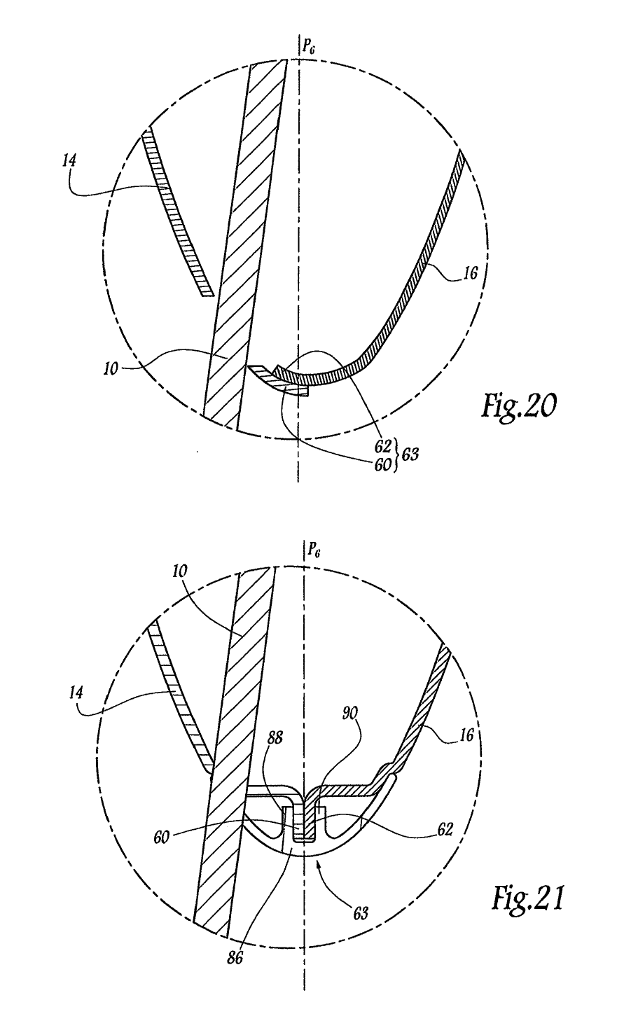

In the sixth embodiment of the invention, shown in FIG. 20, the radially inner edge 60 of the half-shell 14 externally covers the radially inner edge 62 of the half-shell 16, and the edges 60, 62 are welded together, lateral surface against lateral surface. In this case, the shells 14 and 16 are not exactly identical.

In the seventh embodiment of the invention, shown in FIG. 21, the radially inner edges 60 and 62 of the half-shells 14 and 16 are assembled by means of a finish ring 86 clipped onto the edges 60 and 62 by means of two inner ribs 88 and 90. The ring 86 thus forms an assembly beam for the half-shells 14 and 16, which constitutes the radially inner edge 63 of the wheel fairing 12. Optionally, the edges 60 and 62 can be glued or welded to one another prior to positioning the ring 86 as shown.

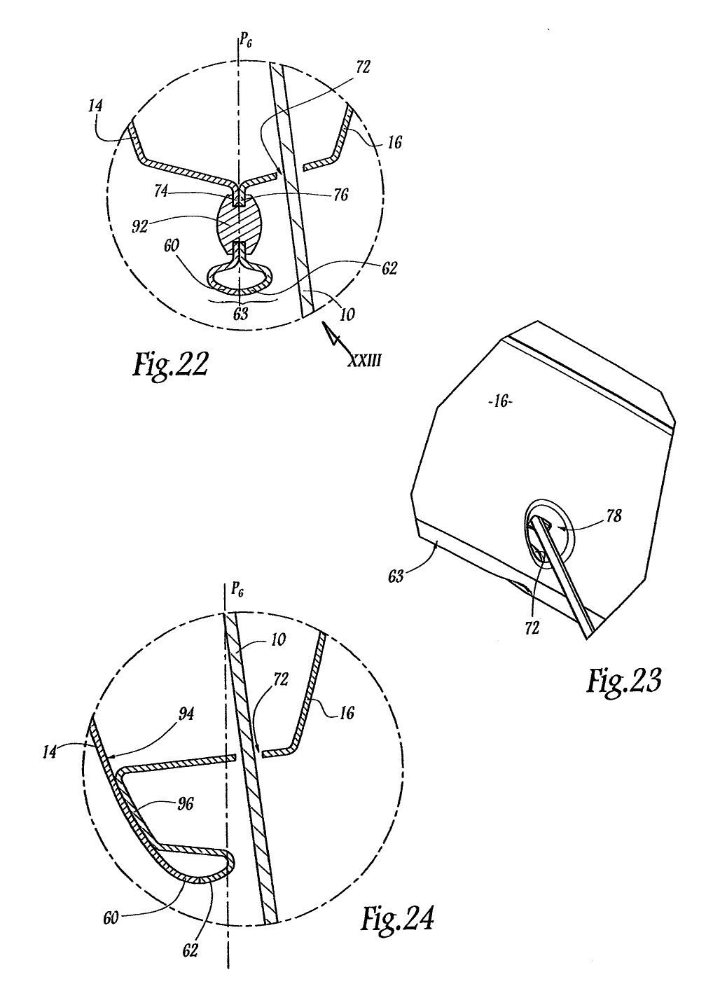

In the eighth embodiment, shown in FIGS. 22 and 23, rivets 92 extend through the half-shells 14 and 16, in the vicinity of their respective radially inner edges 60 and 62. This is done by locally stamping the half-shells 14 and 16 while they are being thermoformed, so as to create two lateral flanges 74 and 76 of the half-shells 14 and 16, which are parallel to the plane P₆ and contact one another along such plane; this enables the rivets 92 to be positioned.

In an alternative, screws, screws/nuts, e.g., or other fasteners, could be used instead of rivets 92, or the portions 74 and 76 of the half-shells 14 and 16 could even be welded to one another.

As shown in FIG. 23, the localized stamping of the half-shells 14 and 16 creates a passage zone 78 for a spoke 10. The spoke 10 extends through the half-shell 16 in a portion of the half-shell that is much more inclined with respect to the plane P₆ than in the other embodiments. As a result, the opening 72 for passage of the spoke 10 can have transverse dimensions that are substantially less than those used in the preceding embodiments.

In the ninth embodiment of the invention, shown in FIG. 24, the half-shell 16 is equipped with eight deep drawings, in the vicinity of its radially inner edge 62, so that a lateral flange 96 of the half-shell 16 comes in support against the inner surface 94 of the half-shell 14. It is then possible to glue or weld the lateral flange 96 onto the surface 94.

As in the preceding embodiment, the opening 72 for passage of a spoke 10 can have relatively small transverse dimensions, insofar as the portion of the half-shell 16 through which the spoke 10 extends is very inclined with respect to the plane P₆.

The technical characteristics of the various embodiments defined hereinabove can be combined with one another. In particular, although welding between the radially inner edges 60 and 62 of the half-shells 14 and 16 is mentioned above, other connecting arrangements are also within the scope of the invention, in particular gluing or mechanical assembly by means of rivets, bolts, or clips.

The wheels of the various embodiments and alternatives mentioned above can be manufactured selectively using any of the methods mentioned with reference to the first and third embodiments, respectively.

The invention is shown in the attached figures of drawings in the case in which the rim 6 is equipped with ribs 38 and 40 for fastening a wire or bead tire, i.e., a clincher tire. It is applicable to any type of rim, in particular a rim provided with a surface for gluing of a tube, i.e., a tubular tire.

According to alternative embodiments of the invention, the wheel fairing 12 can be made not only of thermoformed plastic material but also from plastic material molded by injection, composite material, aluminum or aluminum alloy.

In addition, the invention illustratively disclosed herein suitably may be practiced in the absence of any element which is not specifically disclosed herein.

1. A cycle wheel comprising:
a hub;
a rim comprising a structure for receiving and retaining a tire;
tensioned spokes between the hub and the rim;
a wheel fairing attached to the rim;
said wheel fairing comprising two radially outer edges;
said rim comprising two grooves for receiving the two radially outer edges of the wheel fairing;
said rim exerting, in an area of the two grooves, a centripetal force blocking the radially outer edges of the wheel fairing in the grooves.

2. A wheel according to claim 1, wherein:
each of the radially outer edges of the wheel fairing has a thickness slightly greater than a width of a bottom of a respective one of the two grooves of the rim.

3. A wheel according to claim 1, wherein:
each of the two grooves has a radial depth greater than 0.5 mm.

4. A wheel according to claim 1, wherein:
each of the two grooves has a radial depth greater than 0.8 mm.

5. A wheel according to claim 1, wherein:
each of the two grooves has a radial depth of equal to 1.0 mm.

6. A wheel according to claim 1, wherein:
the two radially outer edges of the wheel fairing are set back, within the wheel fairing, with respect to a transversely outer surface of the wheel fairing.

7. A wheel according to claim 1, wherein:
the rim is made of aluminum or an aluminum-based alloy;
the wheel fairing is made of one of the following:
a plastic material, made by injection molding or thermoforming;
a composite material having a thermoplastic or thermohardening matrix;
aluminum;
an aluminum alloy.

8. A wheel according to claim 1, wherein:
the wheel fairing comprises two half-shells;
each of the two half shells comprises a respective one of the radially outer edges of the wheel fairing;
the two half-shells are affixed to one another in a vicinity of a radially inner edge of the wheel fairing.

9. A wheel according to claim 1, wherein:
the wheel fairing comprises a thermoformed plastic material.

10. A wheel according to claim 1, wherein:
the wheel fairing comprises a pair of transversely spaced apart walls;
each of the walls of the wheel fairing is equipped with a stiffening structure.

11. A wheel according to claim 1, wherein:
the two radially outer edges of the fairing comprise two transversely spaced apart radially outer edges;
the two grooves of the rim comprise two transversely spaced apart grooves for receiving the two radially outer edges of the wheel fairing.

12. A wheel according to claim 1, wherein:
the force exerted by said rim is an radially inwardly directed force maintaining the wheel fairing secured to the rim without screws, rivets, or other mechanical fastener.

13. A wheel according to claim 1, wherein:
the force exerted by said rim is an radially inwardly directed force maintaining the wheel fairing secured to the rim with neither a fastener nor adhesive.

14. A method of manufacturing the wheel of claim 1, said method comprising:
(a) manufacturing an open rim blank by arranging the two grooves on a side of the blank adapted to face the hub of the wheel;
(b) manufacturing the wheel fairing;
(c) engaging the two radially outer edges of the wheel fairing in the two grooves, on a portion of a circumference thereof;
(d) closing the blank around the wheel fairing by maintaining the radially outer edges of the wheel fairing in position in the grooves;
(e) fastening the spokes to the rim;
(f) fastening the spokes to the hub;
(g) tensioning the spokes.

15. A method of manufacturing the wheel of claim 1, said method comprising:
(a′) manufacturing the rim to be provided with the two grooves on a side of the rim adapted to face the hub of the wheel;
(b′) manufacturing the wheel fairing;
(c′₁) bringing the wheel fairing to a temperature below a temperature range for normal use of the wheel, or bringing the rim to a temperature above a temperature range for normal use of the wheel;
(c′₂) radially arranging the wheel fairing inside the rim, with the radially outer edges of the wheel fairing being opposite the grooves of the rim;
(d′) bringing the wheel fairing and the rim to room temperature;
(e′) fastening the spokes to the rim;
(f′) fastening the spokes to the hub;
(g′) tensioning the spokes.

16. A method of manufacturing the wheel of claim 1, said method comprising:
(a″) manufacturing the rim to be provided with the two grooves on a side of the rim adapted to face the hub of the wheel;
(b″) manufacturing two constituent half-shells of the wheel fairing;
(c″₁) mounting a first of the two half-shells on the rim by engaging a first of the two radially outer edges of the first half-shell in a first of the two grooves of the rim;
(c″₂) mounting a second of the two half-shell on the rim by engaging a second of the two radially outer edges of the second half-shell in a second of the two grooves of the rim;
(d″) affixing together respective radially inner edges of the first and second half-shells;
(e″) fastening the spokes to the rim;
(f″) fastening the spokes to the hub;
(g″) tensioning the spokes.

17. A method according to claim 14, wherein:
tension of the spokes and/or the pressure of a tire mounted on the rim are used to exert, on the rim, a centripetal force contributing to a hooping of the radially outer edges of the wheel fairing in the grooves of the rim.

18. A method according to claim 15, wherein:
tension of the spokes and/or the pressure of a tire mounted on the rim are used to exert, on the rim, a centripetal force contributing to a hooping of the radially outer edges of the wheel fairing in the grooves of the rim.

19. A method according to claim 16, wherein:
tension of the spokes and/or the pressure of a tire mounted on the rim are used to exert, on the rim, a centripetal force contributing to a hooping of the radially outer edges of the wheel fairing in the grooves of the rim.

20. A cycle wheel comprising:
a hub;
a rim comprising a structure for receiving and retaining a tire;
tensioned spokes between the hub and the rim;
a wheel fairing attached to the rim;
the wheel fairing comprises a thermoformed plastic material or a composite material having thermoformable matrix.

21. A wheel according to claim 20, wherein:
the wheel fairing includes two half-shells made of a thermoformed plastic material;
the half-shells are affixed to one another in a vicinity of a radially inner edge of the wheel fairing.

22. A wheel according to claim 21, wherein:
each of the half-shells has a respective radially inner edge;
the half-shells are affixed to one another by welding, gluing, or mechanical assembly of the two radially inner edges.

23. A wheel according to claim 22, wherein:
the radially inner edges of the two half-shells are welded to one another, lateral surface against lateral surface or edge surface to edge surface.

24. A wheel according to claim 23, wherein:
the radially inner edges of the two half-shells are welded onto a connecting ring arranged in an inner volume of the wheel fairing.

25. A wheel according to claim 21, wherein:
the radially inner edges of the two half-shells are assembled together by means of rivets or screws.

26. A wheel according to claim 22, wherein:
the radially inner edges of the two half-shells are affixed to one another and covered with a finish ring mechanically holding the edges together.

27. A wheel according to claim 20, wherein:
the thermoformed plastic material of the wheel fairing is a multi-layer sheet having a thickness less than 1.0 mm.

28. A wheel according to claim 20, wherein:
the thermoformed plastic material of the wheel fairing is a multi-layer sheet having a thickness of about 0.5 mm.

29. A wheel according to claim 20, wherein:
the thermoformed plastic material is at least partially transparent;
a decoration is affixed on an inner surface of the wheel fairing and is visible through said thermoformed plastic material.

30. A wheel according to claim 20, wherein:
the rim is provided with two grooves for receiving two radially outer edges of the wheel fairing;
the rim exerts, in areas of each of the grooves, a centripetal force blocking the radially outer edges of the wheel fairing to thereby secure the wheel fairing to the rim.

31. A method of manufacturing a cycle wheel having tensioned spokes between a hub and a rim, the wheel being provided with a structure for receiving and retaining a tire the wheel being equipped with a wheel fairing attached to the rim, said method comprising:
(a1) thermoforming a sheet of plastic material to constitute at least a portion the wheel fairing.

32. A method according to claim 31, further comprising:
(b1) thermoforming two half-shells;
(c1) assembling the two half-shells together to form the wheel fairing;
(d1) mounting the wheel fairing on the rim.

33. A method according to claim 32, further comprising, preceding the thermoforming a sheet of plastic material:
affixing a decoration on a surface of the sheet.

34. A method according to claim 33, wherein:
the affixing a decoration on a surface of the sheet comprises affixing the decoration on the surface of the sheet by sublimation of a film.
